(19) United States
(12) Patent Application Publication
(10) Pub. No.: US 2005/0061974 A1
(43) Pub. Date: Mar. 24, 2005

(54) Method of analyzing material structure using CBED

(75) Inventors: Mi-young Kim, Seoul (KR); Gyeong-su Park, Gyeonggi-do (KR); Young-su Moon, Seoul (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/941,856

(22) Filed: Sep. 16, 2004

(30) Foreign Application Priority Data
Sep. 22, 2003 (KR) 10-2003-0065531

(51) Int. Cl. G01N 23/00

(52) U.S. Cl. 250/310

(57) ABSTRACT

Provided is a method of analyzing a material structure by CBED using a TEM in which structure information such as a stress distribution and the like is analyzed by converging an electron beam on a local area of the specimen. The method includes: (a) detecting experiment HOLZ lines from a diffraction pattern; (b) varying TEM experimental parameters and lattice constants to detect theoretical HOLZ lines by modeling the detected experiment HOLZ lines; and (c) comparing the theoretical HOLZ lines with the experimental HOLZ lines to determine the lattice constants of the specimen.

### BACKGROUND OF THE INVENTION

This application claims the priority of Korean Patent Application No. 2003-65531, filed on Sep. 22, 2003, in the Korean Intellectual Property Office, the disclosure of which is incorporated herein in its entirety by reference.

1. Field of the Invention

The present invention relates to a method of analyzing a material structure using convergent beam electron diffraction (CBED), and more particularly, to a method of analyzing a material microstructure enabling the determination of various information such as a lattice constant, a crystal defect, a stress distribution and the like in a local area of a nanometer region of a specimen material by CBED using a TEM.

2. Description of the Related Art

Raman method, X-ray diffraction method and the like have been used to determine the crystal structure or stress distribution in a micro-area of a material. In the X-ray diffraction method, as shown in FIG. 1A, nearly parallel X-ray beams 11 are irradiated onto a subject specimen 12 at an almost right angle. As a result, a spot pattern 13 can be obtained. From the spot pattern 13, it is possible to obtain information to classify crystal structures. Since the X-ray diffraction method is relatively simple in preparing a measurement specimen or in measuring the specimen, it is most widely used. However, since the X-ray diffraction method uses X-rays as a source for the measurement, its resolution reaches a few tens of microns, and has difficulty in analyzing regions below the resolution.

For the microstructure analysis of a material, an electron diffraction method using a TEM (Transmission Electron Microscope) is widely used. In such electron diffraction methods, CBED (Convergent Beam Electron Diffraction) is gaining popularity. CBED is a method of analyzing a microstructure of a material using a TEM. As shown in FIG. 1B, electron beams 14 are irradiated onto a local area of a subject specimen with a convergent angle, thereby obtaining a disc type diffraction pattern 15. In the CBED, it is possible to observe three-dimensional diffraction in a thick portion of the subject specimen 12 using a dynamic of diffraction. Accordingly, a symmetry between a crystal constant and a lattice is known, and it becomes possible to determine a dots group and a space group and to exactly measure the thickness of the subject specimen. The CBED has a very excellent spatial resolution and thus has an advantage of precisely measuring the crystal structure, the lattice constant, a lattice defect, etc. of a microstructure corresponding to a resolution of 30 nm or so.

From the diffraction patterns 15 obtained from the CBED method, HOLZ lines (Higher Order Laue Zone lines) 16 caused by the crystal plane of the specimen 12 due to the diffraction of electron beams are observed. From the HOLZ lines 16, information regarding the lattice constant and the stress distribution of the specimen 12 can be obtained. For instance, to determine the lattice constant ‘a’ of the specimen 12, convergent electron beams 14 are irradiated onto a local area 17 of the specimen 12 such that a disc type pattern 15 is created. From the created disc type pattern 15, the HOLZ lines 16 are obtained. The obtained HOLZ lines 16 are compared with HOLZ lines obtained by a computer simulation depending on variations of the value ‘a’. The value ‘a’ when the two sets of HOLZ lines are in accordance with each other is determined to be the lattice constant value in the local area of the specimen.

However, since the kinematic simulation of the CBED used in the conventional art does not consider the effects of dynamics, it has a disadvantage of low preciseness. Two kinds of kinematic simulation methods have been used conventionally, but they have the following drawbacks.

1. A method of visually comparing differences between crossing points of the HOLZ lines obtained experimentally is applicable only when the freedom capable of changing the lattice constants (a, b, c, alpha, beta and gamma) of the specimen, i.e., the crystal lattice, is 1. However, in most cases, since two or three lattice constants are concurrently changed, it is difficult to apply the comparison method.

2. A commercial program recently released has an advantage in that an optimal value is searched for while some of six lattice constants are changed by automatic fitting. However, when obtaining HOLZ lines from the pattern obtained experimentally and comparing the obtained HOLZ lines with theoretical values, errors may be very large due to a consideration of only crossing points of the HOLZ lines if the HOLZ lines have not been obtained correctly. Also, even in the method of obtaining the HOLZ lines, as shown in FIG. 2, only a small number of straight lines (14 lines) are considered assuming only the straight lines distributed in an overall area. In this case, since the dynamic effect, which varies according to the thickness of the specimen and requires many more corrections in a thicker specimen, is not considered, the searched theoretical values cause significant difference between the theoretical lines and the actual HOLZ lines.

### SUMMARY OF THE INVENTION

The present invention provides a method of analyzing a micro-structure enabling an exact measurement of various information such as a lattice constant, a crystal defect, a stress distribution and the like in a local area of a nanometer region of the specimen by CBED diffraction using a TEM. In particular, the present invention provides a method of analyzing a microstructure of a material enabling the determination of physical property variations generated in semiconductor processes, at an initial stage.

According to an aspect of the present invention, there is provided a method of analyzing a material structure by CBED using a TEM. The method includes: (a) detecting experiment HOLZ lines from the diffraction pattern; (b) varying TEM experimental parameters and lattice constants to detect theoretical HOLZ lines by modeling the detected experiment HOLZ lines; and (c) comparing the theoretical HOLZ lines with the experimental HOLZ lines to determine the lattice constants of the specimen.

The detecting the experimental HOLZ lines may include: pre-treating an image of the diffraction pattern; detecting the experimental HOLZ lines from the image of the pre-treated diffraction pattern; and correcting the experimental HOLZ lines.

The pre-treating may include: image noise filtering of attenuating noise components existing in the diffraction pattern; and enhancing a contrast of the experimental HOLZ lines that are objects of detection.

The detecting of the experimental HOLZ lines includes: performing a Hough transformation of each pixel of the diffraction pattern image to detect first experimental HOLZ lines; and comparing the first experimental HOLZ lines detected by the Hough transformation with corresponding HOLZ line of the diffraction pattern and selecting corresponding HOLZ lines having high similarity with the first experimental HOLZ lines as second experimental.

The correcting of the experimental HOLZ lines includes: selecting pixels of a portion corresponding to the experimental HOLZ lines in the diffraction pattern image using a snake algorithm by a predetermined amount, defining the selected pixels as control points and determining initial positions of the control points; and correcting the positions of the control points and altering the experimental HOLZ lines to HOLZ lines corresponding to the diffraction pattern to extract position information of the HOLZ line corresponding to the diffraction pattern. The detecting the theoretical HOLZ lines may include: initializing the experimental parameters and the lattice constants value of the specimen; and determining optimal values of the experimental parameters and the lattice constants that enable determination of the theoretical HOLZ lines corresponding to the experimental HOLZ lines while varying the experimental parameters and the lattice constants.

The detecting the theoretical HOLZ lines may be performed by a Bloch simulation.

The theoretical HOLZ lines with the experimental HOLZ lines may include: comparing pixels of the diffraction pattern image including the experimental HOLZ lines and corresponding pixels of the theoretical HOLZ lines; and varying the experimental parameters and the lattice constants of the specimen that determine the diffraction pattern including the theoretical HOLZ lines such that the number of the pixels having identical position information is maximized.

### BRIEF DESCRIPTION OF THE DRAWINGS

The above and other features and advantages of the present invention will become more apparent by describing in detail exemplary embodiments thereof with reference to the attached drawings in which:

FIG. 1A is a schematic diagram illustrating a method of determining a diffraction pattern of a subject material using X-ray diffraction (XRD);

FIG. 1B is a schematic diagram illustrating a method of determining a diffraction pattern of a subject material by CBED (Convergent Beam Electron Diffraction) using a TEM (Transmission Electron Microscope);

FIG. 2 is a photograph of HOLZ lines extracted by CBED using a TEM according to the conventional art;

FIG. 3 is a schematic diagram of an apparatus used in a method of analyzing a material structure by CBED using a TEM according to an embodiment of the present invention;

FIG. 4 is a flowchart illustrating a method of obtaining experimental HOLZ lines included in the method of analyzing a material structure by CBED using a TEM illustrated in FIG. 3;

FIG. 5 is a flowchart illustrating a method of obtaining optimal values of experimental parameters and a material structure constant for forming theoretical HOLZ lines corresponding to the experimental HOLZ lines in the method of analyzing a material structure by CBED using a TEM illustrated in FIG. 3; and

FIG. 6 is a photograph showing pattern matching obtained by comparing experimental HOLZ lines with theoretical HOLZ lines according to the method of analyzing a material structure by CBED using a TEM illustrated in FIG. 3.

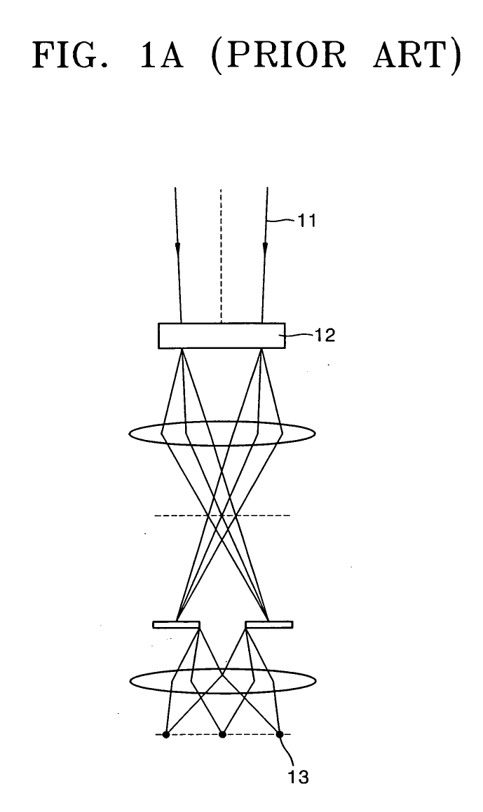

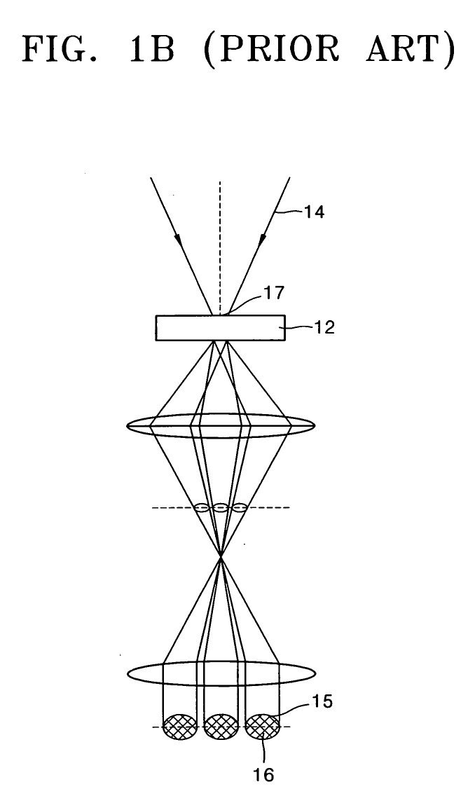

### DETAILED DESCRIPTION OF THE INVENTION

The present invention will now be described more fully with reference to the accompanying drawings, in which exemplary embodiments of the invention are shown. This invention may, however, be embodied in many different forms and should not be construed as being limited to the embodiments set forth herein; rather, these embodiments are provided so that this disclosure will be thorough and complete, and will fully convey the concept of the invention to those skilled in the art.

A method of analyzing a material structure includes: a CBED line detecting operation, i.e., detecting HOLZ lines by CBED used in stress analysis; calculating CBED HOLZ lines using a dynamic simulation of positions of the HOLZ lines; and quantitatively analyzing cross interrelationships in all of the pixels of a pattern around a portion where the HOLZ lines are frequently crossed.

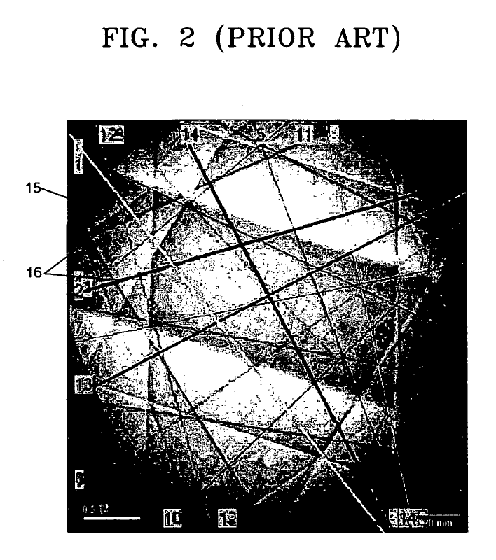

More specifically, the HOLZ lines are detected from a disc type diffraction pattern caused by a specimen being analyzed. Then, the geometrical structure and lattice constant are theoretically determined on the basis of the positions of the detected HOLZ lines. Finally, the positions of the HOLZ lines obtained experimentally and the positions of the theoretical HOLZ lines are compared with each other to determine a final HOLZ line. As a result, it becomes possible to analyze structural information using the lattice constants and the stress distribution in a region of the specimen being measured. For this purpose, an apparatus shown in FIG. 3 is used. In other words, a disc type pattern formed by a TEM 31 using CBED is analyzed by an image memory device 32 and a calculator 34 with results being displayed on a display device 33.

Hereinafter, the detecting of the HOLZ lines using CBED and analyzing stress distribution will be described in more detail.

By converging an electron beam onto a local area of a specimen to be analyzed using the TEM, a disc-shaped CBED pattern is obtained. This disc-shaped pattern contains information regarding the crystal structure and the stress distribution in the region of the specimen through which the electron beam passes. The detecting of the HOLZ lines should be done precisely and efficiently.

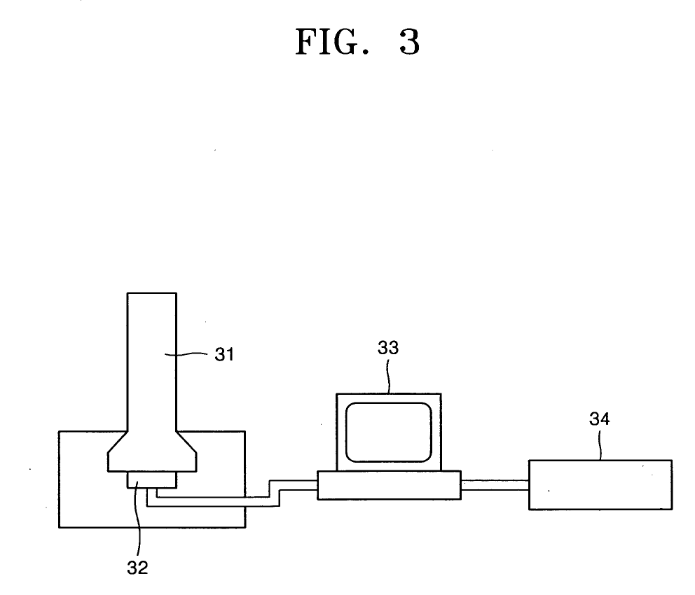

Referring to FIG. 4, the detecting the HOLZ lines includes image pre-treating, candidate line detecting, and candidate line correcting. The image pre-treating is used to remove a variety of image noise components existing in an image input to enhance the processing performance in a subsequent step, or to improve picture quality. In the candidate line detecting, the HOLZ lines are detected from a variety of lines existing in the quality-improved image after the image pre-treating. In the candidate line correcting, the detected candidate lines are corrected such that the detected candidate lines are transformed to HOLZ lines with more precise position values.

The image pre-treating will now be described in more detail. HOLZ lines can easily be visually detected from the disc shaped pattern obtained by irradiating the convergent electron beam on a local area of a specimen, but a computer is required to process and analyze many data. However, images displayed by the display device are influenced by various image environments such as lighting conditions, photograph equipment, experimental conditions and the like, such that serious deterioration of image quality such as an occurrence of noise may be caused. Large deviations in the contrast of a detected vary from image to image, or in different, within a single image. To this end, the pre-treatment is necessary to detect the line.

First, image noise filtering is required to remove or reduce a variety of noise components. Specifically, edge-preserving filtering is used leaving the image feature and removing only the image noise component. The CBED diffraction image is visually shown on a display device. At this time, the display picture is comprised of a plurality of pixels. Edge algorithm of the pixels is performed to determine edge direction and to apply a noise-reducing filtering in the determined edge direction. In other words, in reviewing an initial disc shaped diffraction image, there appears a difference in brightness between pixels of a line and remaining pixels.

For example, when a graph of brightness is drawn with respect to the display as a horizontal axis, the pixels of a line and the remaining pixels have a different brightness, such that an edge portion whose slope is so increased is generated. The image feature of pixels in this edge portion is preserved while the image feature of a portion that is image noise is reduced. Various edge-preserving methods may be used. An edge-preserving method is selected according to the experimental conditions.

Next, a process of enhancing image contrast after performing the image noise filtering is performed. In this process, the contrast between the HOLZ line portion and other portions of the image which noise has been reduced by the image noise filtering is enhanced. For example, a histogram equalization procedure can be performed, which will now be described more specifically. First, the number of pixels of an input image corresponding to all the possible image brightness values is determined and then a histogram of the image brightness values is obtained.

Then, when the distribution of the pixels is within a specific brightness range, it is expanded to a maximum brightness distribution if possible, thereby obtaining the enhancement in the contrast of the input image. In addition to the global method such as the histogram equalization procedure, a local equalization procedure that enhances the contrast may be also applicable. By performing the above procedure, an image of CBED HOLZ lines with a more uniform and more enhanced contrast can be obtained.

The candidate line detecting will now be described in more detail. The candidate line detecting is used to detect candidate lines indicating HOLZ lines that are not perfect but approximate, and includes Hough transformation and candidate line filtering.

Hereinafter, the Hough transformation will be described. When the edge size is larger than a given threshold value, the position information (3-Dimension) of the pixel is transformed into a line parameter region (2-Dmension). By repeatedly applying the above procedure to all pixels of the display device, straight lines corresponding to an accumulative sum that is finally greater than a constant threshold value can be first detected. To increase the number of the first detected lines, the threshold value is set low if possible. The threshold value is experimentally controllable according to the experimental conditions and the types of specimens. In other words, the position information of pixels that are conceivable positioned on the same line of a CBED picture is collected, and it is assumed that these pixels are positioned on the same line. The subject line can be expressed by two values, i.e., a distance from the origin in an X-Y coordinate system and an angle between an x-axis and a straight line that is perpendicular to the subject line and passes through the origin. When a new coordinate system is set on the basis of the two values obtained, the subject line in the x-y coordinate system can be expressed by a point. If the points expressed by the above have an accumulative sum that is greater than a constant threshold value, they are used as a primary candidate line.

Next, the candidate line filtering will be described. The candidate line filtering is performed to filter out the lines not matched with the actual CBED HOLZ lines from the primary candidate lines detected by the Hough transformation. For this purpose, edge direction information of pixels of each of the first candidate lines are collected and only edge direction information corresponding to the direction information of the actual CBED HOLZ lines is used to obtain secondary candidate lines. The similarities can be selectively defined by controlling a deviation of the edge direction information according to the experimental condition and kinds of the specimens. In the present invention, the filtering of the candidate lines may be omitted.

If the secondary candidate lines are detected, the candidate line correction is performed to reduce errors in the actual CBED HOLZ lines. The actual CBED HOLZ lines have deformed shapes that do not correctly accord with the secondary candidate lines. This is because the candidate line assumes a straight line shape as will be seen in the candidate line detecting, which the actual CBED HOLZ lines may be curved or have curved portion and do not completely accord with the secondary candidate lines. Accordingly, it is necessary to refine the detected candidate lines to conform the actual CBED HOLZ lines.

For this purpose, the present invention employs a snake algorithm, which is widely used in the computer vision field. The snake algorithm is indicative of an image algorithm for minimizing unified energy of internal deformation energy applied between control points, each being a construction unit and external potential energy applied to the respective control points of a snake. In other words, under conditions that do not deviate from the restraint characteristics on the geometrical deformation between control points defined in advance, a snake is automatically attached to an adjacent target edge, for example, to an actual CBED HOLZ line, as time elapses, starting from a given initial position of the snake, for example, the position of the candidate line.

This candidate line correcting can be divided into two processes. First, the position of the snake is initialized to designate initial positions of control points. In other words, the number of the control points selected from the candidate lines and the initial positions of the control points are determined. Next, the positions of the control points are repeatedly calculated while repeatedly minimizing the snake energy defined in advance during unit time, starting from the initial positions of the control points. Through this calculation, the candidate lines approach the actual CBED HOLZ lines, and it is possible to detect lines very similar to the actual CBED HOLZ line. As a result, the detected experiment CBED HOLZ lines are straight lines or curved lines.

Thus, a HOLZ line with a very high preciseness is detected from the CBED diffraction pattern obtained experimentally.

Next, the theoretical CBED HOLZ lines are calculated. By using the position value of each of the detected CBED HOLZ lines, i.e., the CBED HOLZ line information obtained experimentally, a theoretical geometrical structure and structure constant are calculated. The geometrical structure means photographic conditions of a TEM, i.e., photographic conditions of a TEM when obtaining a CBED pattern, and the structure constants are lattice constants (a, b, c, alpha, beta, gamma) of a subject specimen for analysis. The experimental conditions are further determined from the experiment results to calculate experiment parameters (ex. an inclination angle of specimen) that are not exactly calculated in the detecting of the HOLZ lines.

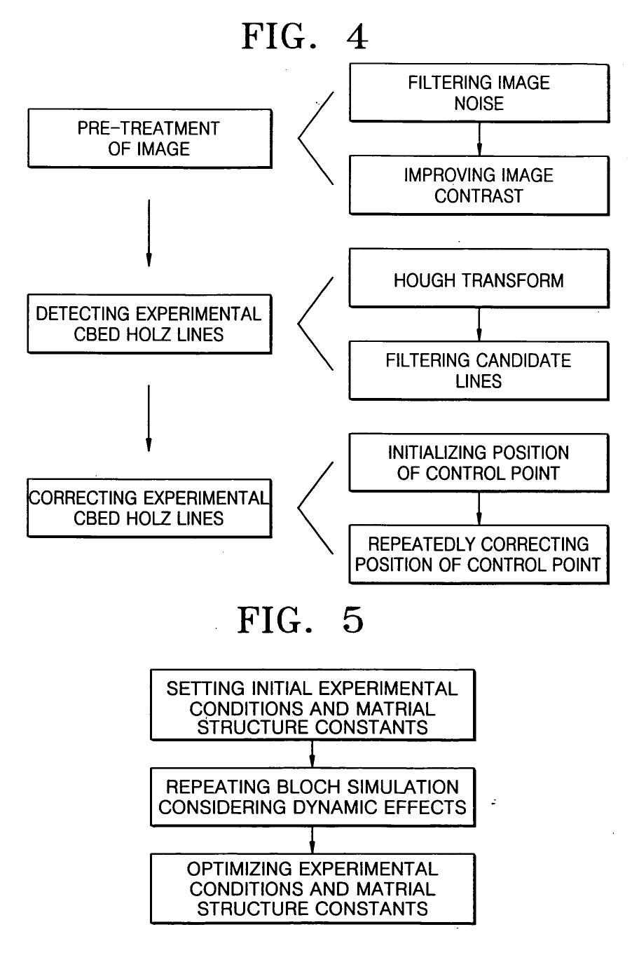

The calculating of the theoretical CBED HOLZ lines will be described in detail with reference to FIG. 5. First, approximate initial values of the experimental parameters, such as CBED beam direction (reference point), pattern rotation, camera length and the like, and initial values of lattice constants of the specimen are determined.

Then, a Bloch simulation considering dynamic effects is carried out on the CBED HOLZ lines, which are obtained from the determined geometrical structure specimen and initial values of the experimental parameters. Simulation methods that can be used include the Bloch simulation, a Multi-slice simulation, etc. However, in the present invention, it is preferable that the Bloch simulation is used. The Bloch simulation is performed by gradually varying the experimental parameters, i.e., the geometrical structure of the specimen and the lattice constants, so that a CBED HOLZ line having a shape similar to the experimental CBED HOLZ line can be obtained. The experimental parameters and the lattice constants are optimized such that the theoretical CBED HOLZ lines obtained from the initial values of the experimental conditions and the lattice constants approach the experimental CBED HOLZ lines. While the optimizing can be performed on the basis of all the experimental CBED HOLZ lines, a limit on the number of the CBED HOLZ lines can be set to increase processing speed. By performing this process, the theoretical CBED HOLZ lines considering the dynamic effects can be obtained. Thus, the experimental conditions and the lattice constants under which the experimental CBED HOLZ lines were obtained can be obtained.

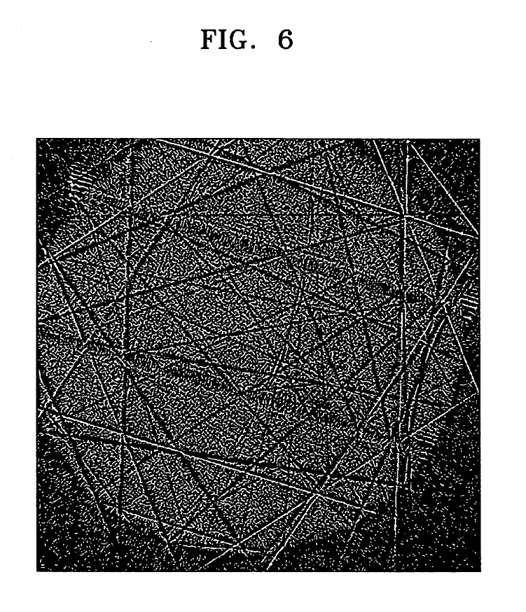

The quantitatively analyzing of the cross interrelationships in all of the pixels of a pattern around a portion where a cross of the HOLZ lines is generated frequently now will be described. The experimental CBED HOLZ lines and the theoretical CBED HOLZ lines are compared with each other. FIG. 6 shows a result of comparing the experimental CBED HOLZ lines and the theoretical CBED HOLZ lines in unit of pixel. For example, if the position information of pixels of an experimental CBED HOLZ line and a corresponding theoretical CBED HOLZ line are the same, a value of 1 is set, while when the position information is different, a value of 0 is set. By doing this, the maximal number of pixels having the same position information, i.e., the geometrical structure and the lattice constants that allow the output value to be a maximum, is searched for. By repeating this procedure, the geometrical structure and the lattice constants for forming the experimental CBED HOLZ lines can be found more exactly.

The lattice constants finally determined through the aforementioned procedure are the lattice constants at a local area of the specimen onto which the electron beam converges. From the lattice constants, a crystal defect, the stress distribution and the like located in the local area of the specimen can be calculated. Specifically, the material structure analysis method using the CBED with the TEM can be utilized in each process because it enables a measurement of the lattice constants of a micro-device having a nanometer dimension, thereby enabling a determination of the stress distribution.

According to the present invention, it is possible to very precisely measure various information, such as lattice constants, crystal defect, a stress distribution, etc., at a local nano-area of a specimen within an error range of 0.05% by CBED using a TEM. In particular, since variations in physical properties that may be generated in a semiconductor process can be found at an initial stage, failure due to a defect existing in the initial stage of the process can be prevented, so that yield of semiconductor devices can be enhanced and searching for a new material capable of enhancing data duration can be performed.

For example, it is known that the material stress distribution in a STI (Shallow Trench Isolation) process directly influences leakage current characteristics. Since three months after the completion of a semiconductor device using the STI process are required to know the actual leakage failure, the stress measuring technique at an initial stage is very useful. Accordingly, by applying the material structure analysis method proposed in the present invention to the STI process, a measurement of the crystal structure and the stress distribution of a semiconductor device at an initial stage becomes possible.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of analyzing a material structure by CBED using a TEM, in which an electron beam is converged onto a local area of a specimen to obtain a disc type diffraction pattern and to thereby enable analyzing structure information including a stress distribution of the specimen material, the method comprising:
(a) detecting experimental HOLZ lines from the diffraction pattern;
(b) varying TEM experimental parameters and lattice constants to detect theoretical HOLZ lines by modeling the detected experimental HOLZ lines; and
(c) comparing the theoretical HOLZ lines with the experimental HOLZ lines to determine lattice constants of the specimen.

2. The method of claim 1, wherein the detecting the experimental HOLZ lines comprises:
pre-treating an image of the diffraction pattern;
detecting the experimental HOLZ lines from the image of the pre-treated diffraction pattern; and
correcting the experimental HOLZ lines.

3. The method of claim 2, wherein the pre-treating the image comprises:
image noise filtering of attenuating noise components existing in the diffraction pattern; and
enhancing a contrast of the experimental HOLZ lines that are objects of detection.

4. The method of claim 2, wherein the detecting of the experimental HOLZ lines comprises:
performing Hough transformation of each pixel of the diffraction pattern image to detect first experimental HOLZ lines; and
comparing the first experimental HOLZ lines detected by the Hough transformation with corresponding HOLZ lines of the diffraction pattern and selecting corresponding HOLZ lines having high similarity with the first experimental HOLZ lines as second experimental.

5. The method of claim 2, wherein the correcting of the experimental HOLZ lines comprises:
selecting pixels of a portion corresponding to the experimental HOLZ lines in the diffraction pattern image by using a snake algorithm, defining the selected pixels as control points and determining initial positions of the control points; and
correcting the positions of the control points and altering the experimental HOLZ lines to HOLZ lines corresponding to the diffraction pattern to determine position information of the HOLZ lines corresponding to the diffraction pattern.

6. The method of claim 1, wherein the detecting theoretical HOLZ lines comprises:
initializing the experimental parameters and the lattice constants value of the specimen; and
determining optimal values of the experimental parameters and the latiice constants that enable determination of the theoretical HOLZ lines corresponding to the experimental HOLZ lines while varying the experimental parameters and the lattice constant.

7. The method of claim 6, wherein the detecting theoretical HOLZ lines is performed by a Bloch simulation.

8. The method of claim 1, wherein the comparing theoretical HOLZ lines with the experimental HOLZ lines comprises:
comparing pixels of the diffraction pattern image including the experimental HOLZ lines and corresponding pixels of the theoretical HOLZ lines; and
varying the experimental parameters and the lattice constants of the specimen that determine the diffraction pattern including the theoretical HOLZ lines such that the number of the pixels having identical position information is maximized.

9. The method of claim 1, further comprising measuring stress distribution of the specimen by using the determined lattice constants.
